(19) United States
(12) Patent Application Publication
(10) Pub. No.: US 2007/0156568 A1
(43) Pub. Date: Jul. 5, 2007

(54) Method and system for distributed trading limit enforcement

(76) Inventors: Vladan D. Jovanovic, Enfield Oakwood (GB); Richard S. Lane, London (GB); Veselin Vesko Stanic, London (GB); Adnan Beganovic, London (GB)

Correspondence Address: BROMBERG & SUNSTEIN LLP, 125 SUMMER STREET, BOSTON, MA, 02110-1618, US

(21) Appl. No.: 11/326,120

(22) Filed: Jan. 5, 2006

(51) Int. Cl. G06Q 40/00

(52) U.S. Cl. 705/37

(57) ABSTRACT

A method for enforcement of trading limits for groups of traders. Each trader's workstation periodically transmits information on the trader's outstanding and executed orders to a risk management workstation. The risk management workstation aggregates this information for the traders in the group and returns this global information periodically to each trader's workstation. When a trader wishes to transmit an order to buy or sell a commodity to an exchange, the trader's workstation determines whether the trade will cause trading limit thresholds to be exceeded, based on the updated information at the trader's workstation. If trading limits would be exceeded, the trader's workstation prevents submission of the order. If trading limits are met, the workstation submits the trade order to the exchange. Thus, bottlenecks caused by centralized trading limit enforcement techniques may be avoided.

### TECHNICAL FIELD

The present invention relates to methods and systems for electronic trading of commodities, and, in particular, to methods and systems for enforcing trading limits for securities traders.

### BACKGROUND ART

Electronic methods of trading have greatly facilitated entry of orders at exchanges for securities and a wide range of commodities. As the number of traders in an organization increases, however, it becomes increasingly difficult for systems to control the risk implicit in multiple, simultaneous real-time transactions. In typical implementations, a central “gatekeeper” system receives orders from traders before transmission to an exchange. The gatekeeper tallies both outstanding orders and executed trades. The gatekeeper checks each order to determine whether the order would cause a trading limit to be exceeded, based on the gatekeeper's running tally of orders and executed trades. If the order is within trading limits, the gatekeeper sends the order to the exchange. If not, the gatekeeper notifies the trader.

For example, any financial instrument whose price is based on or derived from the price of another financial instrument (the “underlying product”) is called a derivative or option. Derivatives are frequently priced by traders using a theoretical model, such as the Black/Scholes model. These models incorporate calculations based on the price of the underlying product and a variety of variables, often denoted by Greek letters and called the “Greeks”, such as delta, gamma, theta and kappa (a.k.a. “vega”):

Delta is the rate of change of fair value of an option with respect to the change in price of the underlying product.

Gamma is the rate of change of an option's delta with respect to underlying price. Thus, Gamma is the second derivative of option value with respect to underlying price.

Theta is the rate at which an option loses value as time to maturity decreases.

Kappa is the sensitivity of an option's value to a change in volatility. Trading limits may be established, for example, based on the delta variable in the derivative pricing model for each order in a trader's outstanding orders or a group of trader's outstanding orders. If an order would cause the delta values of a trader's orders to exceed a trading limit threshold, such as a total delta limit for the group's outstanding trades, the trading group's rules may prevent the trader from placing the order. Of course, trading limits may be based on a wide variety of other factors such as price, volume, duration, etc. for orders.

During times of high trader activity, the queue of orders at the gatekeeper may build, due at least in part to trading limit enforcement, delaying order transmission to the exchange. A method of trading limit enforcement that maintains order transmission transit times at acceptable levels during times of high trader activity is desirable.

### SUMMARY OF THE INVENTION

In a first embodiment of the invention, a method is provided for dynamically enforcing a trading limit for a trader in a group of traders. The trader's workstation sends information about the trader's offers to trade and executed trades to a risk management workstation periodically. The risk management workstation maintains and updates global trade information for the group of traders based on, at least in part, the trade information received from each trader. The risk management workstation transmits updated global trade information to each trader's workstation periodically. When a trader wishes to transmit a trade request to an exchange, the trader's workstation checks that trading limit thresholds would not be exceeded by the trade, based at least in part on the global trade information received from the risk management workstation. If the trade is within limits, the trader's workstation transmits the trade order to the exchange for execution. If the trade would cause trading limits to be exceeded, the trader's workstation prevents the trader from submitting the trade order to the exchange.

In another embodiment of the invention, a method is provided for dynamically enforcing trading limits for a group of traders. A risk management workstation periodically receives trade information updates from each trader's workstation in the group of traders. The trade information includes information on outstanding trades and executed trades for a given trader. Based at least in part on the updated trade information from each trader, the risk management workstation aggregates the trade information and periodically transmits the aggregated trade information to each trader's workstation. Therefore, a trader may determine whether a proposed trade would cause trading limit thresholds to be exceeded by reference to information available locally at the trader's workstation. Thus, traders may transmit permitted trades directly to an exchange without routing the trade to a central risk management workstation. A potential bottleneck is, therefore, eliminated. In a specific embodiment of the invention, the risk management workstation transmits aggregated trade information to a given trader in response to receipt of trade information from the given trader.

In a further embodiment of the invention, a system is provided for distributed enforcement of trading limits. The system includes a computer with a processor, memory and a display. The memory contains instructions that cause the computer to send trading information from the processor to a risk management computer workstation. The trade information includes the given trader's current trading state. The trader's computer receives global trading information from the risk management workstation and can submit a request to trade to an exchange, when the trade is within trading limits. If trading limits would be exceeded by the trade, the trader is prevented by the computer from submitting the request to trade to the exchange.

### BRIEF DESCRIPTION OF THE DRAWINGS

The foregoing features of the invention will be more readily understood by reference to the following detailed description, taken with reference to the accompanying drawings, in which:

FIG. 1 is a block diagram for a trading system, according to an embodiment of the invention;

FIG. 2 is a flow diagram for transmission of trading state information from a trader workstation to a risk management workstation, according to an embodiment of the invention;

FIG. 3 is a flow diagram for collection of trading state information at a risk management workstation, according to an embodiment of the invention;

FIG. 4 is a flow diagram for reception of global trading state information by a trader's workstation from a risk management workstation, according to an embodiment of the invention;

FIG. 5 is a flow diagram for entry of a trade order request after trading limit checking, according to an embodiment of the invention; and

FIG. 6 is a flow diagram for update of the trader's trading state when an update on the trader's outstanding orders is received, according to an embodiment of the invention.

### DETAILED DESCRIPTION OF SPECIFIC EMBODIMENTS

Definitions. As used in this description and the accompanying claims, the following terms shall have the meanings indicated, unless the context otherwise requires:

A “trading limit” shall mean a threshold or group of thresholds that constrain a trader's ability to submit an offer to buy or sell, or accept an offer to buy or sell. For example, a trader may be restricted from submitting an offer to buy a security if buying the security would cause the trader's risk level for that class of security to exceed a numeric limit. A “trading state” for a trader shall mean the status of a set of orders for a trader. Status of the set of orders includes such information as the name of the commodity to be bought or sold in an order, the volume of the order, the price for the order and whether orders are executed, pending or cancelled. A “global trading state” shall mean the aggregate trading state for a group of traders.

In various embodiments of the invention, trading limits on the activities of traders in a group of traders are enforced in a distributed fashion. Distributed enforcement of trading limits allows the number of traders in the group to increase without degradation of transit times for orders from a given trader to an exchange. Such degradation may occur if trading limits are enforced in a centralized location, which may become a system bottleneck. Individual traders periodically transmit current trading state for their own trades to a risk management workstation. The risk management workstation receives periodic transmissions from the traders in the group, aggregates global trading state information and then transmits such information back to each trader periodically. The risk management workstation may also transmit updates to trading limit information to each trader. Trader workstations receive the global trading state information and may receive updated trading limit information. The trader's workstation then updates global trading state information and trading limit information at the trader's workstation. When a trader wishes to submit a given trade order, the trader's workstation determines whether a trading limit would be exceeded by the given trade order, based on the trading state information stored at the trader's workstation and the trading limits. If the trading limit would be exceeded by the proposed order, the trader's workstation can prevent submission of the proposed trade order. If the trading limit would not be exceeded, the trader's workstation transmits the trade order to the exchange for processing. The trader's workstation updates the trader's trading state information stored at the trader's workstation when trade orders are submitted to the exchange or when status information on the trader's outstanding trade orders is received.

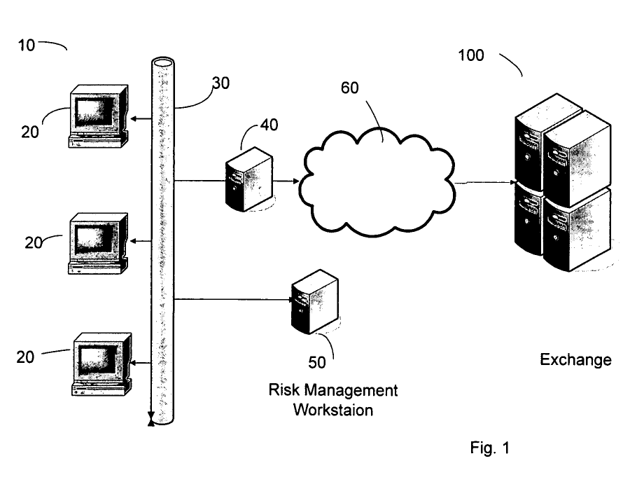

In embodiments of the invention, as shown in FIG. 1, a trader 20 or a group of traders 10 communicates with an exchange 100, both for transmitting orders and receiving offers, by any of a variety of electronic means. Such communication systems 60 may include, without limitation, data networks as are known in the art, such as the internet, using both wired and wireless link-level and physical media, point-to-point communication means, such as the public telephone system, satellite links, a T1 line, a microwave link, a wire line or a radio link, etc. Traders may use any of the variety of computing devices, such as computer workstations 20, personal digital assistants, laptops, etc., as are known in the art, to prepare orders and receive offers. In this description and in any appended claims, such computer devices will be generically called “workstations.” Trader workstations 20 may be connected to an internal network 30 to communicate with each other and to communicate with a risk management workstation (“RMW”) 50. Communications to the exchange from traders may be routed through a gateway processor 40 over the internal network 30. Trader's in a group of traders may also be dispersed geographically and linked electronically, according to any of the variety of means known in the art.

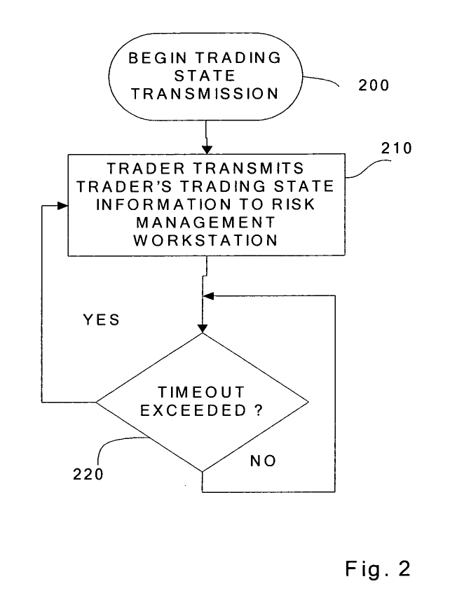

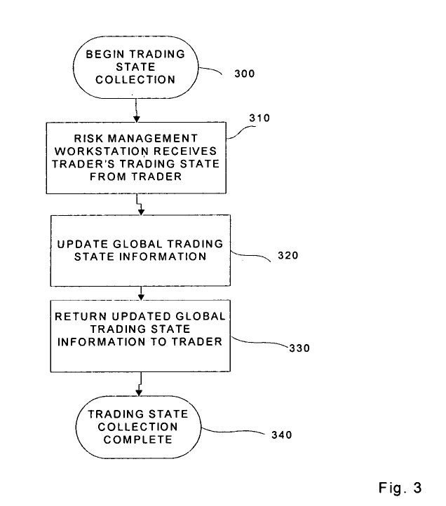

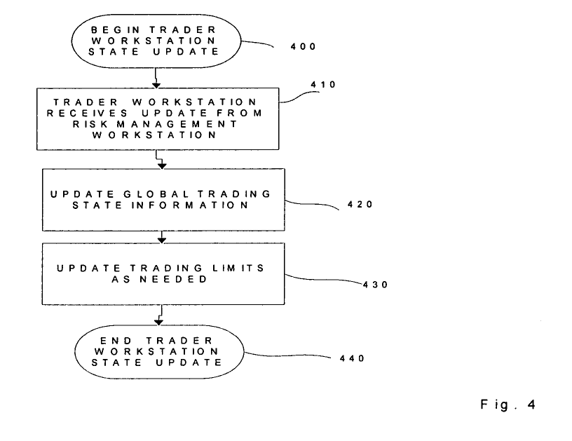

In various embodiments of the present invention, a method is provided for enforcing trading limits on traders in a distributed fashion. As shown in FIG. 2 200, each trader 20 transmits the trader's trading state information periodically 210, 220 to an RMW 50. As shown in FIG. 3 300, the RMW receives trading state information from each trader 310 and updates global trading state information 320, which combines trading state information for each trader in the group. The RMW returns 330 the updated global trading state information to the trader. In some embodiments of the invention, the exchange of data between each trader and the RMW is implemented via a ping-type message-response dialog. In preferred embodiments of the invention, updates are performed approximately once per second at each trader workstation. In other embodiments, the update frequency can be higher or lower than once per second. In other specific embodiments of the invention, the trader's workstation can send updates to the RMW when the trader's trading state changes. In specific embodiments of the invention, the RMW may return other information to the trader along with the global trading state information. Such information may include, for example, updated trading limit information. Each trader upon receipt 410 of the updated information from the RMW, as shown in FIG. 4 400, updates trading information maintained locally at the trader's workstation 420, 430 (e.g., the global trading state, etc.) and the update completes 440.

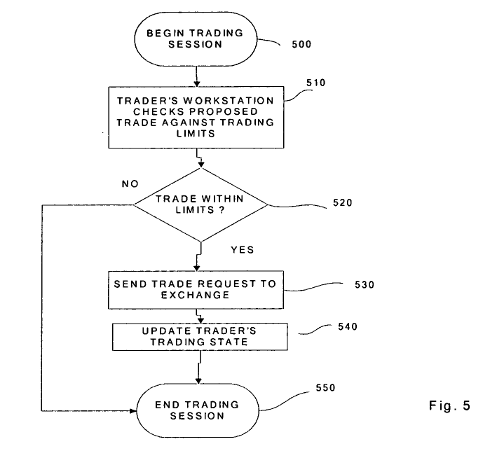

When a trader wishes to send a trade request (offer to buy or sell) to an exchange 500, as shown in FIG. 5, the trader checks 510 the trade request against the trading state information and trading limits maintained at the trader's workstation 20. The information maintained locally at the trader's workstation includes the updated global trading state information. If the trade is within trading limits 510, in light of the trader's trading state information as updated with global trading state information received from the RMW, the trader sends 530 the trade request to an exchange for execution. (Since the individual trader maintains data on both the trader's trading state and the global trading state, enforcing trading limits both for the individual trader and across the group of traders is possible.) The trader then updates 540 the trader's trading state. If the trade is not within trading limits, the trader's workstation prevents 520 the trader from submitting the trade order to the exchange and the trading session terminates 550. On the next update from the trader to the RMW, the submitted trade order will be reflected in the trader's transmitted trading state. The RMW's global trading state information will be updated and disseminated to each trader on each trader's next update. Thus, a trade request is not held up in a queue of requests to the RMW for trading limit checking, when the trader wishes to trade. Advantageously, the trader need only consult information maintained locally at the trader's workstation and then act accordingly. Further, the RMW can maintain global trading state information by receiving periodic transmissions of each trader's trading state information. This approach eliminates the need for the RMW to receive individual messages for each trading order that is submitted or whose status changes. This approach facilitates scalability of trading limit enforcement, according to various embodiments of the invention.

In a specific embodiment of the invention, a given trader's trading state includes trades of derivatives. Trading limits placed on the trader's trades may include limits on the value of delta for each trade in a group of trades. Alternatively, trading limits may include limits on the value of delta and gamma for each of the trader's trades in a group of trades. Further, such trading limits may include limits on delta and/or gamma for trades in a given class for a group of traders.

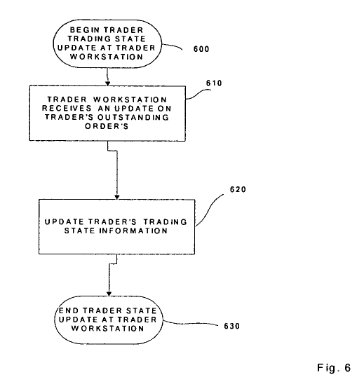

As shown in FIG. 5, the trader's workstation can update the trader's trading state on orders submitted by the trader to an exchange by adding the submitted order to the trading state information. Further, as shown in FIG. 6 600, information on the trader's submitted orders is updated 620 by the trader's workstation (e.g., order was executed, cancelled, or modified, etc.) as information on the trades is received 610 from the exchange 630.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer exec structure form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer execustructure form (e.g., via an interpreter), or the source code may be converted (e.g., via a translator, assembler, or compiler) into a computer executable structure form.

The computer program may be fixed in any form (e.g., source code form, computer execustructure form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive. Other variations and modifications of the embodiments described above as will be apparent to those skilled in the art are intended to be within the scope of the present invention as defined in the appended claims.

What is claimed is:

1. A method of dynamically enforcing a trading limit for a given trader in a group of traders, the given trader using a processor with a display, comprising:
sending the given trader's trading state from the processor to a computer workstation;
receiving at the processor the global trading state for the group of traders from the computer workstation; and
preventing submission of a request from the processor to trade when a trade would cause the trading limit to be exceeded, based at least in part on the received global trading state.

2. A method according to claim 1, further including:
submitting a request from the processor to trade when the trade is within the trading limit, based at least in part on the received global trading state.

3. A method according to claim 1, wherein sending the trading state and receiving the global trading state are repeated periodically.

4. A method according to claim 2, wherein the processor updates the given trader's trading state when submitting a request from the processor to trade.

5. A method according to claim 1, wherein the processor updates the given trader's trading state when the processor receives a trade order status update.

6. A method according to claim 1, wherein sending the trading state further includes sending trading limit information.

7. A method according to claim 1, wherein receiving the global trading state further includes receiving trading limit information.

8. A method of dynamically enforcing trading limits for a group of traders, each trader using a processor with a display, comprising:
receiving the trading state from a given trader at a computer workstation;
updating a global trading state for the group of traders at the computer workstation using the trading state from the given trader; and
transmitting the updated global trading state to the given trader.

9. A method according to claim 8, wherein transmitting the updated global trading state to the given trader is performed in response to a message transmitted by the given trader to the computer workstation.

10. A method according to claim 8, wherein transmitting the updated global trading state further includes sending trading limit information.

11. A system for dynamically enforcing a trading limit for a given trader in a group of traders, the system comprising:
a computer including a processor, memory and a display, the memory containing instructions that cause the computer to:
send the given trader's trading state from the processor to a computer workstation;
receive a global trading state for the group of traders from the computer workstation; and
prevent submission of a given request from the processor to trade when the given request would cause the trading limit to be exceeded, based at least in part on the received global trading state.

12. A system according to claim 11, wherein the memory contains further instructions that cause the computer to submit the given request to trade when the given request to trade is within the trading limit, based at least in part on the global trading state.

13. A system for dynamically enforcing trading limits for a group of traders, the system comprising:
a computer workstation including a processor, memory and a display, the memory containing instructions that cause the computer to:
receive from a given trader in the group of traders, the given trader's trading state;
update a global trading state at the computer workstation for the group of traders using the given trader's trading state; and
transmit the updated global trading state to the given trader.

14. A system according to claim 13, the system further comprising:
a computer including a processor, memory and a display, the memory containing instructions that cause the computer to:
send the given trader's trading state to the computer workstation;
receive the global trading state from the computer workstation; and
prevent submission of a request from the processor to trade when the request would cause trading limits to be exceeded, based at least in part on the received global trading state.

15. A computer program product for use on a computer system for dynamically enforcing a trading limit for a given trader in a group of traders, the trader using a processor with a display, the computer program product comprising a computer usable medium having computer readable program code thereon, the computer readable program code including program code for:
sending the given trader's trading state to the computer workstation;
receiving a global trading state from the computer workstation; and
preventing submission of a request from the processor to trade when the trade would cause the trading limit to be exceeded, based at least in part on the received global trading state.
